(19) United States
(12) Patent Application Publication
(10) Pub. No.: US 2004/0054893 A1
(43) Pub. Date: Mar. 18, 2004

(54) Method and system for a file encryption and monitoring system

(76) Inventor: Anthony Ellis, New York, NY (US)

Correspondence Address: JEFFREY FURR, 253 N. MAIN STREET, JOHNSTOWN, OH, 43031, US

(21) Appl. No.: 10/065,119

(22) Filed: Sep. 18, 2002

(51) Int. Cl. H04L 9/32

(52) U.S. Cl. 713/165; 713/202; 705/51

(57) ABSTRACT

A system designed for file encryption and monitoring that allows remote access verification for individual files and allows the File Owner to control access permission and usage of file by specific user or group of users. The purpose of the system is to encrypt and automatically distribute protected file to authorized users, and then monitor file usage by specific users, control individual usage rights of protected files once they have been given to user, contact users via messaging function, sort, search and export specific users or groups of users. It does this by: Secure encryption of file using high level encryption algorithm; Creation of password key templates which contain access rights set by the author. The system can associate the file with one or a group of key templates; Automatic addition of authorized user. This can be done via third party payment system or by File Owner.

### BACKGROUND OF INVENTION

1. Field of the Invention

This invention relates to the art of an electronic security system for electronic objects such as documents, e-mail, images, video and audio clips and other objects that can be transmitted electronically via a network, modem or other means throughout the Internet.

2. Description of Prior Art

Electronic security systems have been proposed for managing access to electronic information and electronic documents so that only authorized users may open protected information and documents. Several software tools have been developed to work with particular document readers such as Adobe Acrobat Exchange and Adobe Acrobat Reader.

A need still exists for improved systems for providing access to encrypted information by authorized users and which prevents unauthorized users from gaining access to the encrypted information, and prevents authorized users from violating the usage rights of information. There is need for a system which will allow publishers, corporations and individuals to automatically distribute protected files to authorized users while still maintaining control over the usage of that file. A system which will allow File Owners to enforce the usage rights of their file regardless of the location of the file.

There is a need for an improved, all-encompassing solution which incorporates document encryption, secure automatic-distribution, file usage monitoring and tracking, user database management and instant messaging for all users and files.

Current systems incorporate the encryption of the file and limited file monitoring, leaving out many of the other necessary elements. There is need for a system which protects a document from unauthorized access, distribution, document copying, password sharing and any other unauthorized activity. A system which will allow automatic distribution of protected file by integrating with third party payment systems and/or remote servers. A system which provides detailed usage information on distributed files and File Owners. A system which allows owners of the file to revoke access privileges for a specific user or group of users at any time. A system which allows advanced database searches and sorting to create specific lists of users which can be exported for use in other software. A system which allows the File Owner to send instant messages to users or a group of users of a specific file.

In prior art, U.S. Pat. No. 6,334,118 discloses a software rental system and method providing at least one rented program permitting at least one service to a customer with a customer's response means. U.S. Pat. No. 6,301,660 discloses a computer system having a protection mechanism for protecting the contents of a file. The protection mechanism has at least one Viewer program, at least one challenge associated with the Viewer program and the file, and at least one response with private keying material that it can access. U.S. Pat. No. 6,289,460 is for a “Document management system” which allows pre-designated users at remotely located computer-based systems to perform document management.

U.S. Pat. No. 6,289,450 discloses an invention that provides for encrypting electronic information such as a document so that only users with permission may access the document in decrypted form. The process of encrypting the information includes selecting a set of policies as to who may access the information and under what conditions. A remote server stores a unique identifier for the information and associates an encryption/decryption key pair and access policies with the information. Software components residing on the author's computer retrieve the encryption key from the remote server, encrypt the information, and store the encrypted information at a location chosen by the author.

U.S. Pat. No. 6,289,450 discloses an invention that provides for encrypting electronic information such as a document so that only users with permission may access the document in decrypted form. The process of encrypting the information includes selecting a set of policies as to who may access the information and under what conditions. A remote server stores a unique identifier for the information and associates an encryption/decryption key pair and access policies with the information. Software components residing on the author's computer retrieve the encryption key from the remote server, encrypt the information, and store the encrypted information at a location chosen by the author.

U.S. Pat. No. 6,272,636 discloses a digital product execution control which contemplates production of a final version of a digital product and subsequently imposes execution control on that digital product. U.S. Pat. No. 6,236,971 discloses a system for controlling the distribution and use of digital works using digital tickets which are used to entitle the ticket holder to exercise some usage right with respect to a digital work. U.S. Pat. No. 6,092,080 and 5,832,499 disclose a digital library system that includes: 1) a data capture mechanism that includes data transfer and cataloguing mechanisms, 2) an asset management system for access and storage management of data, and 3) a distribution system for distributing the data and system functionality.

U.S. Pat. No. 6,049,789 discloses a software pay-per-use (PPU) licensing system. The PPU licensing system includes one or more licensor license management system (LMS) and one or more licensee LMS. Each licensee LMS includes one or more components that operate to grant pay-per-use licenses for software applications, including data collection on amount of usage licenses granted, and to monitor operational states of the pay-per-use license granting and data collection operations, including periodic reporting of state and usage license granted data to a licensor LMS. U.S. Pat. No. 5,930,357 discloses an object to provide a method of managing contracts for licensed program use with which a licensor is able to confirm whether or not a contract for using a program has been properly kept by the user, as well as provide a system capable of utilizing the managing method. U.S. Pat. No. 5,625,690 discloses a pay per use system for encoding the unauthorized use of computer software which uses an encryption program that encode original software to produce secured software. U.S. Pat. No. 5,606,609 discloses a system to determine the integrity or the signatory of an electronic document by embedding a security object.

The present invention allows the authoring user or other controlling party to maintain access control over the electronic information.

The need for a method for controlling material that has been distributed electronically in a manner that works better for publishers, allows the turning off of the ability to use the file for remote users, is efficient, quick, and easy to use shows that there is still room for improvement within the art.

### SUMMARY OF INVENTION

The preferred embodiment(s) of the invention is summarized here to highlight and introduce some aspects of the present invention. Simplifications and omissions may be made in this summary. Such simplifications and omissions are not intended to limit the scope of the invention.

The object of the present invention is to provide a system and method for encrypting electronic information so that access to the information can be controlled by the author, publisher, licensor or other controlling party.

A further object of the present invention is to provide a system and method for encrypting electronic information so that access to the information can be dynamically changed without the necessity of collecting or redistributing the encrypted information.

The present invention is a file encryption, monitoring and database system that allows remote access verification for individual files and allows the File Owner to control access permission and usage of file by specific user or group of users.

The system is used to encrypt and automatically distribute protected file to authorized users, and then monitor file usage by specific users, control individual usage rights of protected files once they have been given to user, contact users via messaging function, sort, search and export specific users or groups of users. It does this by

:1)Secure encryption of file using high level encryption algorithm.

2)Creation of password key templates which contain access rights set by the author. The system can associate the file with one or a group of key templates.

3)Automatic addition of authorized user. This can be done via third party payment system or by File Owner. User data is added to the database automatically.

4)Auto-generation of password for that specific user and file. Once a user has been authorized, a password key containing the usage rights for that file and user is generated. The file download link and password key is distributed to authorized user via E-mail. The download system only allows file to be downloaded a pre-defined amount of times.

5)Installation of rights enforcement monitor on user's PC when the file is opened for the first time. Rights enforcement monitor checks user access rights via periodic HTTP/SSL connection with remote server.

6)Rights enforcement monitor decrypts file once password key rights have been verified by the remote server.

7)Access rights can be changed or revoked by creator of file, this change will affect the user's file access.

8)Creator of file can send html or text message to specific users of specific files using the monitoring component.

9)Creator of file can create specific lists of users using any recorded data criteria. These lists can be contacted via the messaging system, E-mailed using the E-mail system, or the data can be exported for use in other software.

The process is more encompassing, efficient, effective, accurate, functional and easier to implement for the End User than the current art.

### BRIEF DESCRIPTION OF DRAWINGS

Without restricting the full scope of this invention, the preferred form of this invention is illustrated in the following drawings:

FIG. 1 shows an overview of the system 1;

FIG. 2 shows overview of System Arhcnitecture;

FIG. 3 shows a flowchart on how an End User accesses a protected file;

FIG. 4 shows an End User accessing a protected file;

FIG. 5 shows an overview of File Owner Use;

FIG. 6 shows protected file Distribution Methods;

FIG. 7 shows a User using multiple Computers;

FIG. 8 shows a flowchart on a User accessing a file;

FIG. 9 shows an overview of Password Key Templates; and

FIG. 10 shows an overview of the monitor messaging function.

### DETAILED DESCRIPTION

The preferred embodiment of the invention is a process consisting of a system of scalable software and server systems which allow encryption, secure distribution and usage rights enforcement of distributed digital information. The system 1 is a file encryption and monitoring system that allows remote access verification for individual files and allows the File Owner to control access permission and usage of file by specific user or group of users.

The system is used to encrypt and automatically distribute protected file to authorized users, and then monitor file usage by specific users, control individual usage rights of protected files once they have been given to user, contact users via messaging function, sort, search and export specific users or groups of users. It does this by:1)Secure encryption of file using high level encryption algorithm.

2)Creation of password key templates which contain access rights set by the author. The system can associate the file with one or a group of key templates.

3)Automatic addition of authorized user. This can be done via third party payment system or by File Owner. User data is added to the database automatically.

4)Auto-generation of password for that specific user and file. Once a user has been authorized, a password key containing the usage rights for that file and user is generated. The file download link and password key is distributed to authorized user via E-mail. The download system only allows file to be downloaded a pre-defined amount of times.

5)Installation of rights enforcement monitor on user's PC when the file is opened for the first time. Rights enforcement monitor checks user access rights via periodic HTTP/SSL connection with remote server.

6)Rights enforcement monitor decrypts file once password key rights have been verified by the remote server.

7)Access rights can be changed or revoked by creator of file, this change will affect the user's file access.

8)Creator of file can send html or text message to specific users of specific files using the monitoring component.

9)Creator of file can create specific lists of users using any recorded data criteria. These lists can be contacted via the messaging system, E-mailed using the E-mail system, or the data can be exported for use in other software.

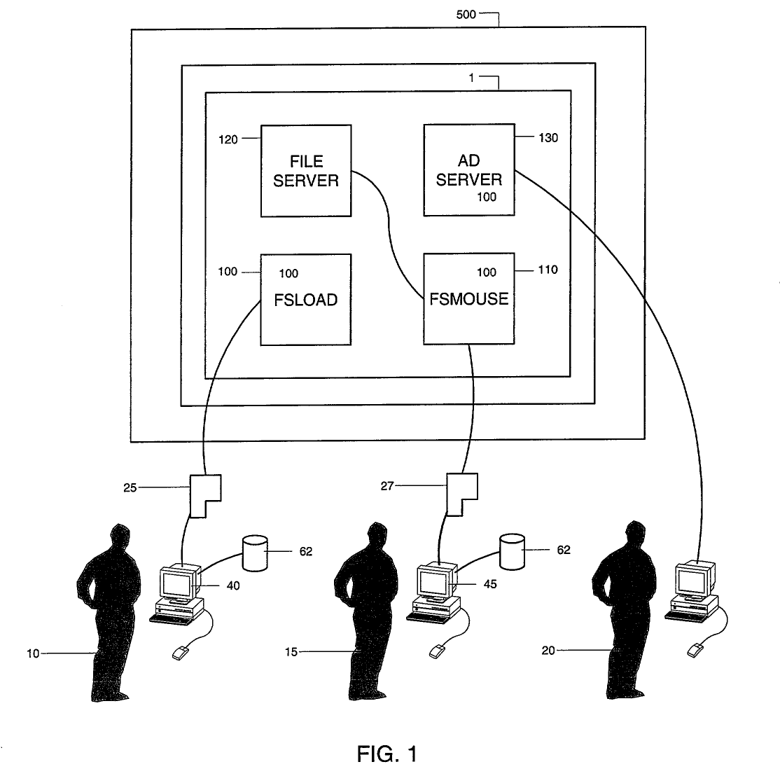

As shown in FIG. 1, the system 1 has a File Owner 10, End User 15 and Administrator 20. The File Owner 10 have documents, and other types of electronic files 25 that they want to protect and monitor using this system 1. FIG. 1 illustrates a functional diagram of a computer network for World Wide Web access from a plurality of File Owner 10 and End User 15 to the Web site 120. Access the Web site 120 can be accomplished directly through a Internet Service Provider, or any other means by which connection is made to remote Internet servers.

The File Owner 10 and End User 115 contact the web site 120 using an informational processing system capable of running an HTML (Hyper Text Markup Language) compliant Web browser such as Microsoft's Internet Explorer, Netscape Navigator or Opera. A typical personal computer with an operating system running a Web browser can be used. The exact hardware configuration of computer used by the File Owner 10 and End User 15, the brand of operating system 62 or the brand of Web browser configuration is unimportant to understand this present invention. And those skilled in the art can conclude that any HTML compatible Web browser is within the true spirit of this invention and scope of the claims.

End User 15 is the recipient of the File Owner's 10 documents or files 25 that are protected by the system 1. The End User 15 can be a customer, co-worker, client or anyone receiving the protected information. Anyone who the File Owner 10 chooses distributes their protected files to.

Administrator 20 is the controller of the overall system. The Administrator controls File Owner 10 accounts, File Owner permissions and File Owner billing.

Many of the programming techniques including the designing and writing of web pages and databases are well known in the art and therefore not covered here.

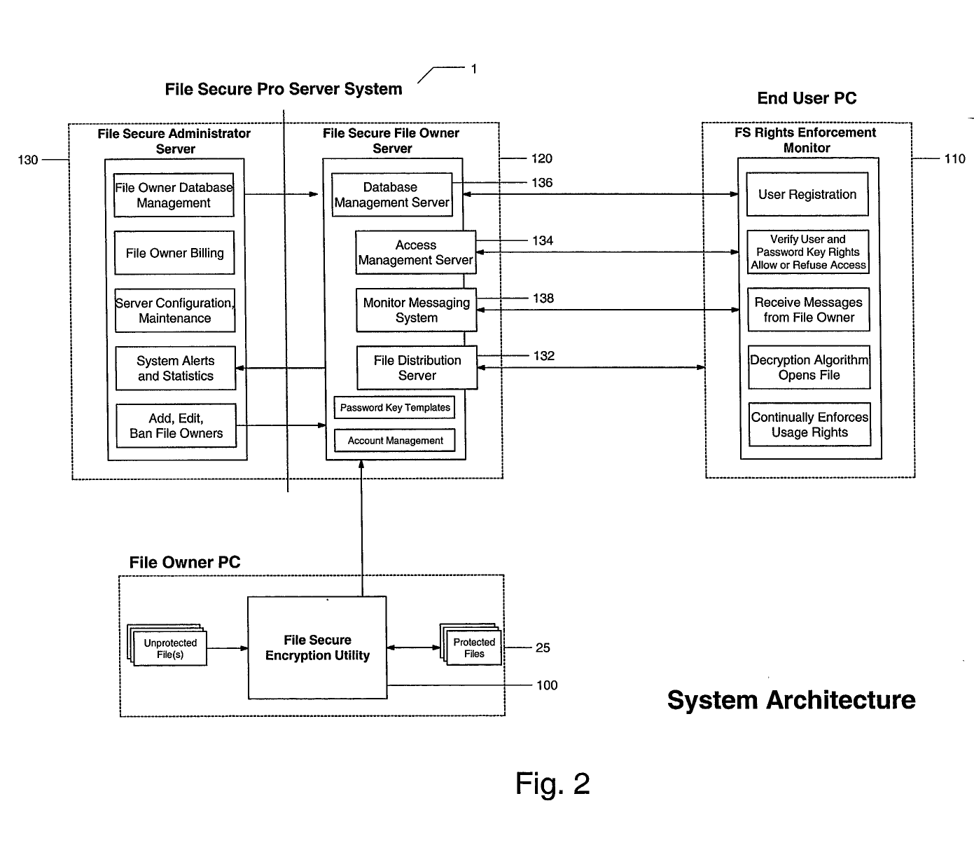

As displayed in FIG. 2, in the preferred environment, the overall system 1 consists of 8 major components, FS Encryption Utility 100, FS Rights Enforcement Monitor 110, the File Secure File Owner Server 120, the File Secure Administrator Server 130, the File Distribution Serve 132, the Access Management Server 134, the Database Management Server 136 and the Monitor Messaging System 138.

The FS Encryption Utility 100 is an encryption and uploading utility. It is launched on the File Owner's 10 computer 40. File Owners 10 choose the file(s) 25 they wish to encrypt and subsequently upload them to the File Secure File Owner Server 120. The FS Encryption Utility 100 encrypts the file(s) 25 using a high level encryption algorithm, and then uploads the file(s) to the File Secure File Owner Server 120. where rights will be set by the File Owner and they will be distributed by the File Distribution Server.

The FS Rights Enforcement Monitor 110 is the monitoring component which enforces the file access and usage rights. It is installed on the End User's 15 PC 45 and is activated when the End User 15 attempts to open any file 25 protected by the system 1.

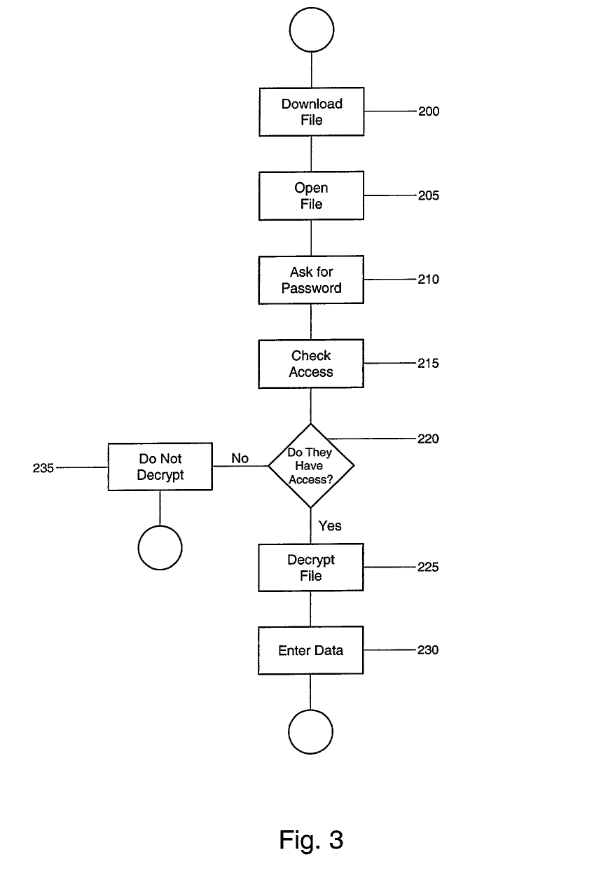

As shown in the Flowchart in FIG. 3, the End User 15 downloads the file 25 from the File Distribution Server, step 200 and opens the file 25, step 205. The system 1 will ask the End User 15 for a password and some personal data in step 210. When the End User 15 enters it, the FS Rights Enforcement Monitor 110 will open an secure SSL connection with the Access Management Server 134 to verify that the End User 15 has access to view this file 25, step 215. Step 220 asks if the End User 15 does have access. If yes, the FS Rights Enforcement Monitor 110 will receive usage rights for that password from the Access Management Server 134, and then decrypt and open the file, step 225. The system 1 will enter the End User's 15 updated personal information into the Database Management Server 136 for this File Owner 10. If no in step 225, then the End User 15 does not access to the file 25, and the system 1 will not decrypt the file 25 and deny access. The file will remain encrypted and inaccessible.

By accessing the File Secure File Owner Server 120 through a communication means 95, the File Owner 10 has the ability to change or revoke any or all elements of End User 15 access permissions at any time, for that file 25 or for any file 25 the End User 15 may have registered on the system 1. The system 1 does this by requiring the FS Rights Enforcement Monitor 110 to attempt to verify password and user status each time someone opens the file 25. Each time a file protected by this system is opened, the FS Rights Enforcement Monitor 110 attempts to open a secure SSL link with the remote Access Management Server 134 to get the current access status of that user and password.

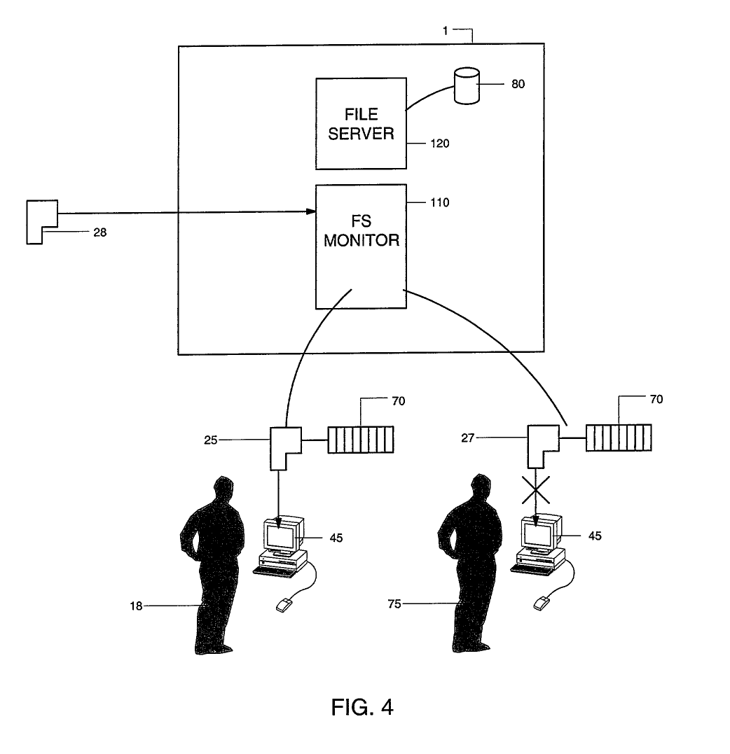

In the preferred embodiment, the system 1 controls usage of a file 25 based on the permissions set in the Access Management Server 120 for that specific file 25, the FS Rights Enforcement Monitor 110 can control, monitor and/or prevent the End User's 15 printing of file 25, copying text of file 25, screen capture of file pages, editing or changing of file 25 and concurrent usage of the file 25. As shown in FIG. 4, only the set number people can view the file 25 with one specific password 70. FS Rights Enforcement Monitor 110 will also expire the file 25 according to the permission settings set in the Access Management Server. In the preferred embodiment, the expiration period for file access can be any period from a one minute to 5 years.

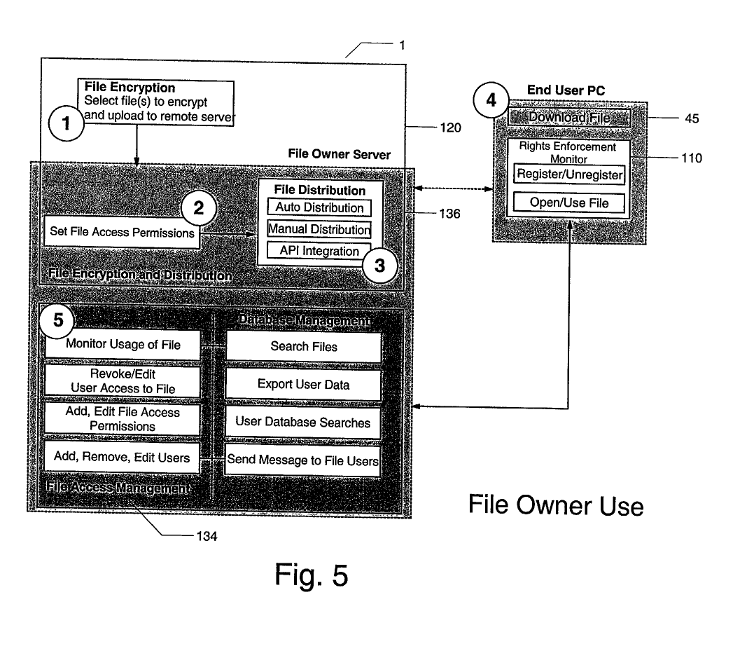

As shown in the overview in FIG. 5, the File Secure File Owner Server 120 is the File Owner's 10 access point to system features including the Access Management Server 134, Database Management Server 136 and File Distribution Server 132 and the Monitor Messaging System 138. This allows File Owners 10 to have access to their protected and unprotected Files 25, End User data 80. File Owners access the File Secure File Owner Server 120 scripts using their username and password. In this area, the File Owner 10 can do the following:

♦View account activity

♦View File Owner account information

♦Use Database Management Server 136 to:oDo advanced database search for files.

oDo advanced database search for Users.

oDo advanced database search for Password KeysoExport list of user data to text file.

oDelete users or filesoview a list of currently uploaded files and access activity for specific files.

oChange/Edit User DataoView User Access for specific files

♦Use the Access Management Server 134 to:oSet global key permissions for files by editing master key template for that file.

oCreate additional password key templates for files oChange/Edit or Revoke permissions for specific user

♦Use the File Distribution Server 132 to:oManually distribute a file to a user or a list of usersoGenerate a list of password keys and export dataoSet automatic distribution integration with third party payment systemointegrate into existing server system using API integration

♦Use Monitor Messaging Server 138 to:oBroadcast html or text message to a specific user or group of users. oForward URL to a specific user or group of users.oE-mail a specific user or a group of users. The FS Administrator Server 130 is the server system that allows the owner 90 of the system 1 to control File Owners 10 and other elements of the system 1. The Administrator 20 accesses the system 1 via the FS Administrator Server scripts 400.

In this area the Administrator 20 can do the following:

♦View system Alerts

♦View server statistics

♦Manage Daily charges. This is the auto billing script which bills the File Owners automatically monthly.

♦Edit Billing settings for payment gateway.

♦Ban Users. Allows Admin to ban malicious File Owners.

♦Change configuration settings♦Back up database♦View list of current File Owners and data regarding their system usage, and current status.

♦Edit, Lock or Ban a specific File Owner.

♦Do advanced database search for File Owners♦Export list of File Owner data to text file.

♦Delete File Owners♦Send E-mail message to a File Owner or group of File Owners.

The File Owner 10 uses the system 1 to protect a file 25. To protect a file 25 the File Owner 10 must first use the FS Encryption Utility 100 utility to encrypt and upload the file 25 to the File Secure File Owner Server 120. Then, the File Owner 10 can proceed to set the access permissions for that specific file 25 along with setting the distribution method.

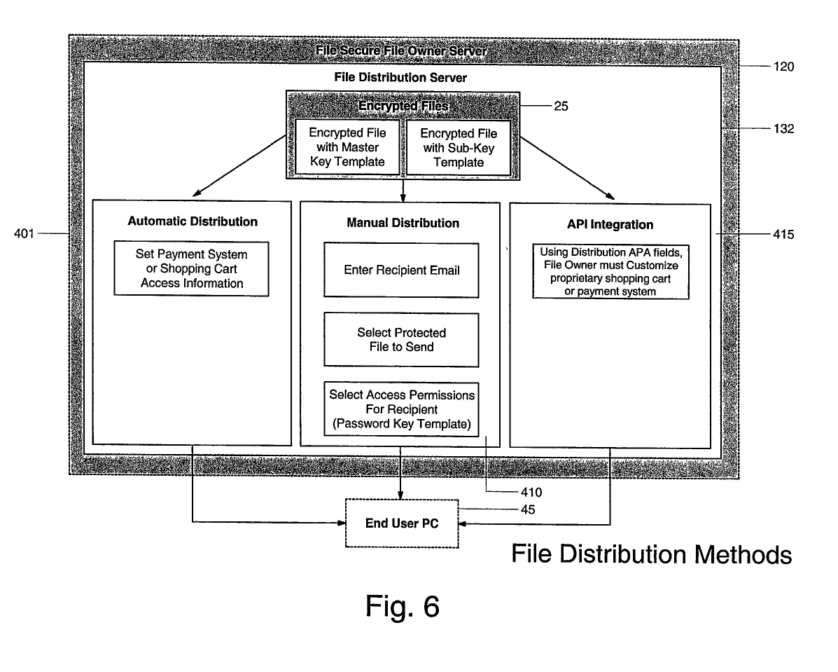

In the preferred embodiment, there are three distribution methods, Automatic 405, Manual 410 and API integration 415 as shown in the overview in FIG. 6. Automatic distribution 405 automatically integrates the distribution into the File Owner's payment system or shopping cart 510. Once their customer's order is approved, they will be automatically entered into the Database Management Server 138 and E-mailed a download link and a password 515 for access. Manual distribution 410 requires the File Owner 10 to manually enter the End User's E-mail address 520 into the system 1. Then the File Distribution Server 120 will automatically E-mail the new End User's 15 a download link to the file 25 and a unique access password.

To change access rights for an End User 15, the File Owner 10 searches for that specific End User 15 in the Database Management Server 140 and then changes the End User's 15 access rights. If the File Owner 10 locks the End User's 15 access then the next time the End User 15 tries to open the file 25, they will be denied access.

In the preferred embodiment, there are three levels of file locking♦File Level—which locks the file and all users of the file 25.

♦End User level—Locks specific End User's 15 entire account, and prevents them from accessing any file protected by this system that they may have been accessing previously.

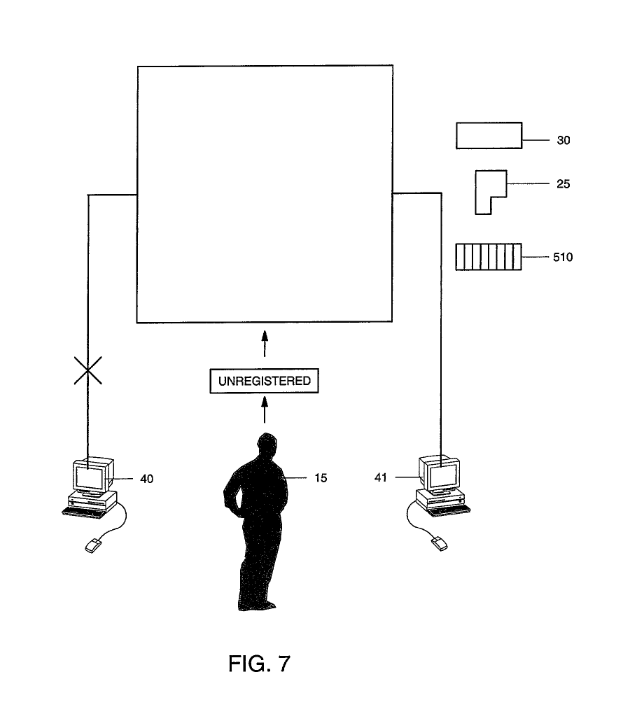

♦Password Level—This prevents access for specific End Users 15 to specific files 25. This is the most specific locking. It allows a File Owner 10 to lock an End User's 15 access to one file 25, while allowing them to access other files they may have registered. Basically their account is still active, and only the locked password is affected. The End Users 15 will use the system 1 for downloading and viewing files 25. To view any file 25 protected by the system 1, the End User 15 must first download the file 25 as shown in FIG. 7. All End Users 15 are e-mailed a unique download link and password for their file 25 via File Distribution Server 132. Once the file 25 has been downloaded the End User 15 will click the file 25 to complete the installation. During installation, the FS Rights Enforcement Monitor 110 will also be installed on the End User's PC. Once installed, the End User 15 will be asked for their password. When entered, the system 1 will open a secure SSL connection with the Access Management Server 130 and verify their access status and rights and then launch the FS Rights Enforcement Monitor 110 registration window. Requiring the End User 15 to enter the password and register only happens when first opening the file 25. Once registered, the file 25 will decrypt and open. For the life of the file, the FS Rights Enforcement Monitor 110 will continue to verify and enforce usage rights to that file based on the permissions it receives from the Access Management Server 134.

While other systems that attach a unique password to a specific computer face the problem of not allowing users to move the file. The current invention does not tie an End User 15 to a specific PC 40, thereby allowing the file 25 to be moved to another PC 41. All the End User 15 has to do is click to open the file 25, and perform the UNREGISTER function. This will unregister their current password and allow them to register the file 25 on another PC.

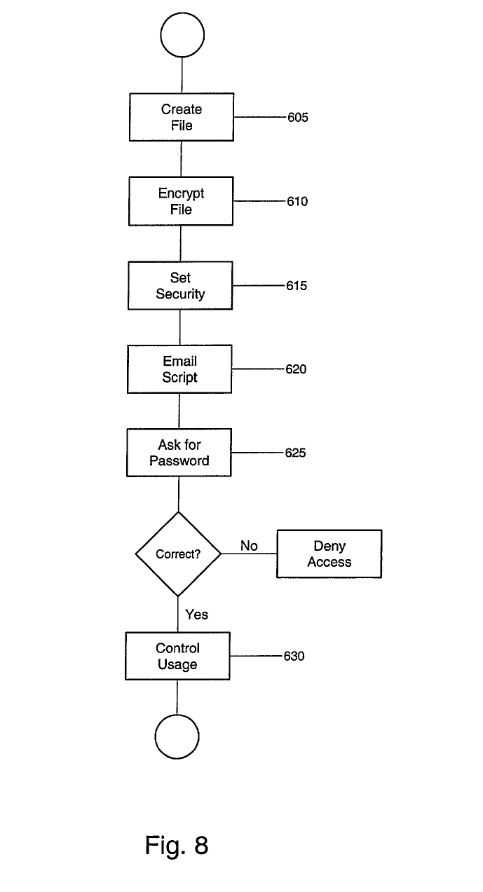

Operation s FIG. 8 gives the steps in creating an encrypted file 25. In the preferred embodiment, a File Owner 10 creates a file 25 using Adobe Acrobat or some other file generation means, step 605. Using the system 1, the file 25 is encrypted and uploaded to the File Secure File Owner Server 120 at designated website 610. Each File Owner 10 gets a virtual account that is hosted on the Administrating server 130. Once the file 25 is uploaded to server 120, the File Owner 10 logs on to the server 120 and then sets the security permissions for that specific file 25 using the Access Management Server 134, step 615. In the preferred embodiment, the following permissions can be controlled: Allow or revoke ability to open file, allow concurrent users (file sharing), Allow printing or specific number of printouts allowed, Allow editing of file, Allow print screen function when viewing file, Allow copy/paste of file data, set file access expiration date or period, Set watermark, allow file to be moved to another pc and set required registration data.

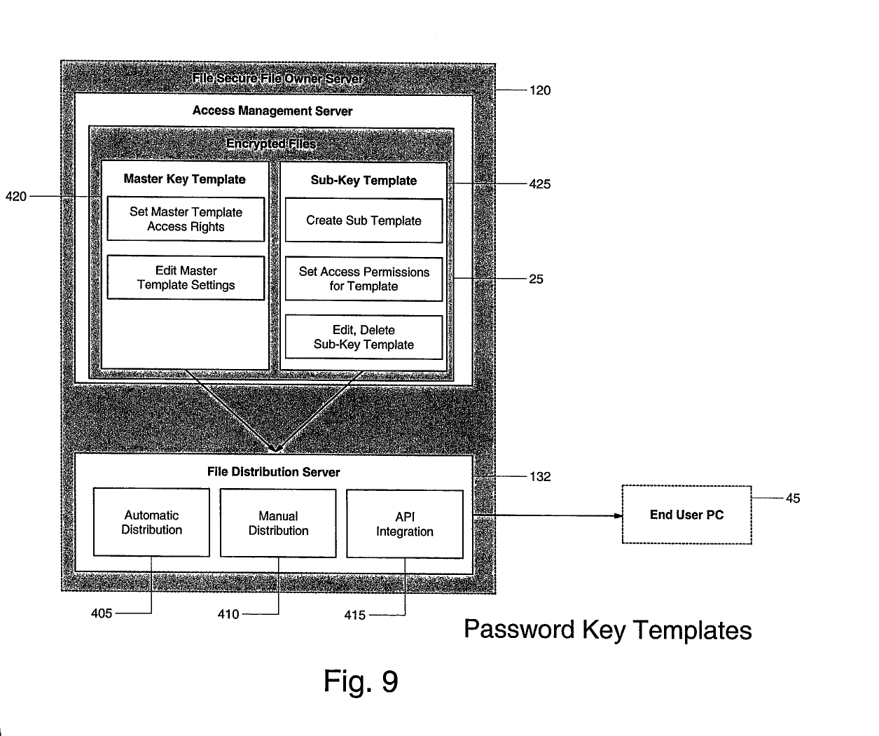

Permission settings for each file are stored as Key Templates as shown in FIG. 9. By default, each file has a Master Key Template 420 that must be set before the file can be distributed. In addition to the Master Key Template 420, the Access Management Server 134 also allows the File Owner 10 to create Sub-Templates 425 which can be attached to any file 25 when a different set of permissions is needed. There can be an unlimited number of Sub-Templates 425.

Once the permissions are set, files 25 are ready to be distributed by the File Distribution Server 132.

The End User 15 will open and view the file 25 protected by the system 1 using the following steps. The File Distribution Server will e-mail the End User 15 their unique download link and password, step 620. The End User 15 will then download the protected file. Next, the user 15 must install the file, at this installation the system will check for the presence of the FS Rights Enforcement Monitor 110. If found, the system will continue with installation of the file, if not found, the system 1 will begin automatic download of the monitor. The FS Rights Enforcement Monitor 110 will automatically install on the End User's computer system. And then ask for the End User's 15 password and personal information to complete registration, step 625. The End User 15 data is then verified by the Access Management Server 134, which subsequently updates the Database Management Server 136 with the user's data. Immediately after verification, the file is decrypted and opened and the FS Rights Enforcement Monitor 110 then begins to track and control the usage of this file based on the rights allowed for this specific password and user, 630.

The Access Management Server 134 along with the FS Rights Enforcement Monitor 110 will control the usage of the file 25 by the End User 15 in real time. Even though the End User 15 has downloaded the file 25 to the End User's computer, the File Owner 10 still has control. The FS Rights Enforcement Monitor 110 enforces the permissions on the End User's 15 computer 40, and is in constant communication with the Access Management Server 120 through a SSL connection with the remote server. In the preferred embodiment, the system 1 can track the number of openings of the file 25, track the number of printings of the file 25, change any and all usage permissions for that End User 15 if requested by the File Owner 10, deactivate an End User's 15 password so that access is permanently denied if requested by the File Owner 10. Using the Monitor Messaging System 138, the File Owner 10 also has the ability to send an instant message directly to the End User via the FS Rights Enforcement Monitor 110. The File Owner 10 also has the ability to E-mail the End User directly using the File Distribution Server E-mail Function.

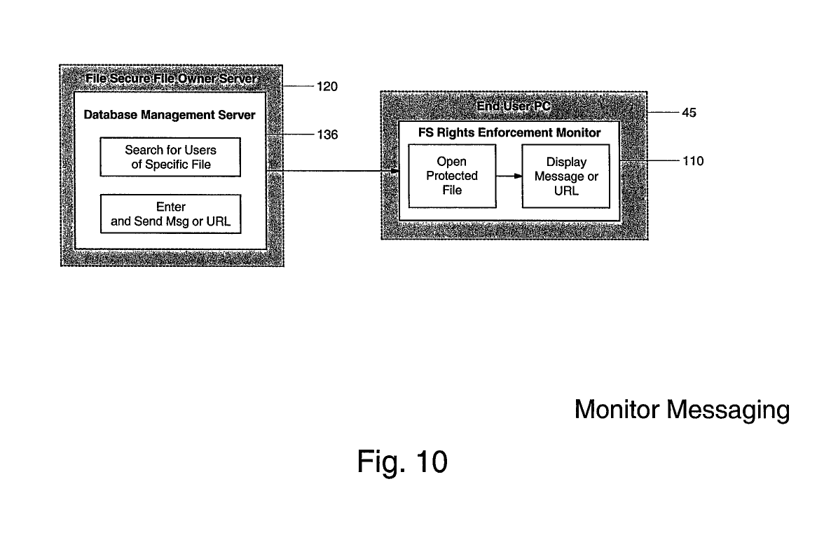

The File Owner's 10 Server Interface is set up to allow the File Owners 10 to be able to control their files 25. There can be unlimited File Owners 10. Each File Owner 10 is given their own database 140 on the FS File Owner Server 120. The system 1 has an advanced interface allowing them to perform routine functions to handle thousands of End Users 15. This system 1 interface allows a File Owner 10 to track and monitor file 25 usage, deactivate a specific End User's 115 ability to access a specific file 15, deactivate a specific End User's 15 ability to access any file 25 used by the system 1, deactivate all End User's 15 ability to access a specific file 25, do advanced searches for specific information, users, files or passwords, broadcast message directly to End Users 15 via the rights monitor as shown in FIG. 10, create specific lists of End Users to E-mail, export, or distribute a new file 25 to and view current statistic such as account activity, space usage, number of users, billing data, etc.

In the preferred embodiment there is only one system administrator 20. The Administrator control interface is where all aspects of the system are controlled such as the ability to create, remove, deactivate File Owners 10, monitor File Owner 10 usage, handle billing issues, back up entire database 140, view system 1 activity, do advanced searches for File Owners 10 and handle system 1 configuration.

To control file 25 usage the system 1 creates monitoring components or plug ins 30 for each specific file type. The components 30 control the physical usage of the file 25 (saving as new name, copying text, print screen, etc.). It controls the ability to view the file 25 by first checking the status of the password the End User 15 enters when they click to open the file 25. If the password is active (not deactivated) it will open the file 25. If the password is not active the file will not open. If the password is active, the monitoring component 30 obtains the latest rights for that user and password and then decrypts the file 25.

Each password key holds the permissions for a specific file 25. In the preferred embodiment there is only one unique specific password key for a specific End User's access to a specific file 25. If the system 1 deactivates a specific password, the End User 15 who was assigned that password for the specific file 25, won't be able to open that file 25. The system 1 can also deactivate a specific End User 15. This will lock all files 25 that particular End User 15 has registered.

Advantages The previously described version of the present invention has many advantages. Including many elements missing in all prior art. It provides a more comprehensive method to securely and automatically distribute electronic information in a manner that allows hands free payment system integration and distribution without the need for File Owner interaction with the system. It allows for improved file usage tracking, monitoring and rights enforcement. It integrates critical database management tools to manage, organize and sort thousands of users. The system also encompasses a large scale E-mail and messaging capability. Allowing File Owner to remain in contact with any users or group of users of their protected files.

Although the present invention has been described in considerable detail with reference to certain preferred versions thereof, other versions are possible. For example, the functionality and look of the web site could use different or new protocols or an Intranet could be used. Therefore, the point and scope of the appended claims should not be limited to the description of the preferred versions contained herein.

That which is claimed is:

1. A method of controlling usage and distribution of electronic information comprising: Securing encryption and secure distribution of a file or digital information using a download generating script; Installing a monitoring component at user end; and having monitoring component checks file access rights at time intervals through a communication means and having monitoring component control access to file or digital information based on password rights retrieved from remote server.

2. The method of controlling usage and distribution of electronic information of claim 1, wherein access and usage rights to the file can be changed or revoked.

3. A method of controlling usage and distribution of electronic information of claim 1, whereas, said securing encryption is done by a File Owner.

4. A method of controlling usage and distribution of electronic information of claim 1, whereas, said securing encryption is done by a File Owner on File Owner's computing device and then uploaded to an access site using a communication means.

5. A method of controlling usage and distribution of electronic information of claim 1, whereas, said securing encryption is done by a File Owner on File Owner's computing device and then uploaded to a server using a communication means.

6. A method of controlling usage and distribution of electronic information of claim 1, whereas, said monitoring component checks file password rights at time intervals through a communication means to a remote server.

7. A method of controlling usage and distribution of electronic information of claim 1, whereas, said monitoring component checks file password rights through a communication means to a remote server when the file is accessed.

8. A method of controlling usage and distribution of electronic information of claim 1, whereas, allowing a File Owner to change access and usage rights to a given file.

9. A method of controlling usage and distribution of electronic information of claim 1, whereas, allowing a File Owner to change access and usage rights for a given End User.

10. A method of controlling usage and distribution of electronic information of claim 1, whereas including the steps of having an auto-generation of password for file access and having said password being used by the access monitor to control the access rights to the file.

11. A method of controlling usage and distribution of electronic information of claim 1, whereas including the step of having a password being used by the monitoring control unit to control the access rights to the file.

12. A method of controlling usage and distribution of electronic information of claim 1, whereas including the steps of having an auto-generation of password for file access and having said password being used by the monitoring control unit to control the access rights to the file.

13. A method of controlling usage and distribution of electronic information of claim 1, whereas including the step of distributing the file manually.

14. A method of controlling usage and distribution of electronic information of claim 1, whereas including the step of distributing the file automatically.

15. A method of controlling usage and distribution of electronic information of claim 1, whereas including the step of distributing the file automatically using API integration.

16. A method of controlling usage and distribution of electronic information of claim 1, whereas having an administrator function.

17. A method of controlling usage and distribution of electronic information of claim 1, whereas including the steps of allowing the End User to move the file from one computing device to another.

18. A method of controlling usage and distribution of electronic information of claim 1, whereas including the steps of allowing the End User to move the file from one computing device to another by unregistering the file and reregistering the file.

19. A method of controlling usage and distribution of electronic information of claim 1, whereas including the steps of having an access control database on a computing device.

20. A method of controlling usage and distribution of electronic information of claim 1, whereas including the steps of having an access control database on a computing device with data for each file user.

21. A method of controlling usage and distribution of electronic information of claim 1, whereas including the steps of having user management database on a computing device.

22. A method of controlling usage and distribution of electronic information of claim 1, whereas including the steps of having user management database on a computing device with data for each file user.

23. A method of controlling usage and distribution of electronic information of claim 1, whereas including the steps of having the ability to send instant messages users instantly via the monitoring component.

24. A method of controlling usage and distribution of electronic information, comprising: Having an FS Encryption Utility function, Having an FS Rights Enforcement Monitor function Having a File Secure File Owner Server, Having a Database Management Server, Having a Access Management Server, Having a File Distribution Server; and Having a Message Monitoring System.
